(19) United States
(12) Patent Application Publication
(10) Pub. No.: US 2020/0339467 A1
(43) Pub. Date: Oct. 29, 2020

(54) METHOD OF BENDING GLASS SHEETS

(71) Applicant: SAINT-GOBAIN GLASS FRANCE, COURBEVOIE (FR)

(72) Inventors: Bernard NGHIEM, ARSY (FR); Jean-Philippe SCHWEITZER, CHAMANT (FR)

(21) Appl. No.: 16/958,923

(22) PCT Filed: Dec. 21, 2018
(86) PCT No.: PCT/FR2018/053518

§ 371 Date: Jun. 29, 2020

(30) Foreign Application Priority Data
Dec. 29, 2017 (FR) 1763379

(51) Int. Cl. C03B 40/033; C03B 23/03; C03C 21/00; B32B 17/10; B32B 37/18; B32B 38/00

(52) U.S. Cl. CPC C03B 40/033; C03B 23/03; C03C 21/002; B32B 17/10036; B32B 17/10137; B32B 17/10935; B32B 2605/08; B32B 38/0012; B32B 2250/40; B32B 2307/412; B32B 2315/08; B32B 2605/006; B32B 37/182

(57) ABSTRACT

The present invention relates to a process for simultaneous bending of superposed glass sheets comprising the use of a parting agent that generates gas evolution under the bending conditions.

The present invention relates the field of curved laminated glass, in particular for applications as motor vehicle glazing. It relates more particularly to a process for simultaneous bending of superposed glass sheets comprising the use of a parting agent that generates gas evolution under the bending conditions.

In the production of curved laminated glass such as a motor vehicle windshield, it is often necessary to undertake the simultaneous bending of the glass sheets that it is desired to subsequently assemble as a laminated glazing. More specifically, the glass sheets are superposed one on top of the other and heated at a temperature appropriate for obtaining the simultaneous and similar deformation of the glass sheets via a gravity bending, press bending and/or suction bending process. The glass sheets thus bent must be separated from one another before the laminating operations. After separation, the lamination is then carried out by inserting a lamination interlayer generally consisting of a sheet of polymer such as polyvinyl butyral.

However, sometimes the glass sheets adhere to one another by superficial melting during the bending operations. To prevent this, it is known to apply a parting agent between the glass sheets before undertaking the bending. As examples of commonly used parting agents, mention may be made of gypsum, talc, calcium carbonate, kieselguhr or mica. However, it has been observed that these parting agents, which are generally pulverulent, may be the cause of “pinholes” on the glass sheets which result, in the final glazing, in optical defects that are detrimental from the esthetic point of view. These pinholes are attributed to the deformation of a glass sheet around particles of parting agent during the bending. When the upper glass sheet rests on the particles of the parting agent and when the glass becomes deformable (typically above 600° C.), the pressing of each particle may give rise to a deformation in the upper and/or lower sheet.

The objective of the present invention is therefore to offer a process for the simultaneous bending of superposed glass sheets (generally two glass sheets) that makes it possible to overcome the drawbacks mentioned above. More particularly, the Applicant has observed that it was possible to significantly reduce, or prevent, the appearance of pinholes via the use of a parting agent that generates gas evolution under the bending conditions. Thus, the present invention relates to a process for the simultaneous bending of superposed glass sheets comprising:
the provision of a first glass sheet;
the application of a parting agent to one surface of the first glass sheet;
the provision of a second glass sheet superposed on the first glass sheet, the parting agent being between the first glass sheet and the second glass sheet;
the heating of the glass sheets at a temperature that allows the bending thereof; and
the simultaneous bending of the glass sheets;
   characterized in that the parting agent generates gas evolution under the bending conditions.

Without wishing to be bound to any one theory, it is assumed that the creation of a gas cushion between the two glass sheets resulting from the gas evolution of the parting agent at the time of bending has the effect of easing or annulling the pressure exerted by the particles of the parting agent on the surface of the glass sheets.

The gas evolution originates from the decomposition, under the bending conditions, of the parting agent. Within the meaning of the present invention, the expression “bending conditions” in connection with the parting agent is understood obviously to mean the bending temperature reached by the glass sheets, in particular the maximum temperature, but also the temperature variation kinetics, in particular the temperature rise ramp, and the direct atmospheric environment of the parting agent, which is in particular in a highly confined atmosphere between the two glass sheets. Thus, the gas evolution of the parting agent preferably occurs mainly at temperatures above 450° C., or above 500° C., or even above 550° C. and may extend up to temperatures of 600° C., 620° C., or 640° C., or even 670° C. It is obviously not excluded that the decomposition of the parting agent can give rise to a gas evolution outside of these temperature ranges. A portion, generally a minority portion, of the gas evolution may occur for example below 450° C. and/or above 640° C. without adversely affecting the effectiveness of the parting agent according to the invention. The parting agent preferably has a loss of mass of at least 10%, or at least 20%, or even at least 30% by weight between 450° C. and 640° C. The volume of gas released by the parting agent between 450° C. and 640° C., preferably between 500° C. and 620° C., is advantageously at least 0.05 l/g, or at least 0.1 l/g or even at least 0.2 g/l, and may range up to 1 l/g, or 0.5 l/g. The temperature ranges of the gas evolution of the parting agent, and also its loss of mass and the volume of gas released may be determined by thermogravimetric analysis, optionally combined with a thermodifferential analysis, a mass spectrometry and/or an infrared spectrometry, with a heating rate of 50° C./min and under a stream of the same chemical nature as that released by the parting agent during the bending, for example a stream of CO₂.

The known parting agents, such as calcium carbonate, talc, silica, alumina or else kaolin, do not make it possible to satisfy these criteria. Thus, the parting agent according to the invention is not typically chosen from calcium carbonate, talc, silica, alumina or kaolin. Indeed, although some of them are capable of releasing a gas evolution, this does not take place under the bending conditions. This gas evolution takes place either well before achieving the temperatures necessary for the bending (dehydration of the calcium carbonate for example) or above the bending temperatures temperatures (decomposition of the calcium carbonate or of the talc for example), taking into account bending conditions that involve in particular a high temperature rise ramp and a confined atmosphere.

The gas evolution generated by the parting agent is preferably an evolution of carbon dioxide (originating for example from the decomposition of carbonate groups) and/or of water (originating for example from the release of crystallized water and/or from the decomposition of hydroxyl groups).

Appropriate parting agents may be identified using thermal analyses (in particular thermogravimetric and/or thermodifferential analyses). The parting agent is advantageously chosen so that the decomposition residue thereof is chemically inert with respect to the glass sheets. Furthermore, the parting agent and the residue after decomposition must not melt in the temperature ranges of the process. The parting agent is preferably chosen from the family of carbonates, in particular the family of magnesium and/or aluminum carbonates, hydroxides, in particular aluminum and/or magnesium hydroxides, hydrated mixed silicates, in particular hydrated aluminum and/or magnesium silicates, or a mixture thereof. A “mixed silicate” is understood to mean any silicate of natural or synthetic origin containing several (two or more) types of cations chosen from alkali metals (for example Na, Li, K) or alkaline-earth metals (for example Be, Mg, Ca), transition metals and aluminum. Within the meaning of the present invention, the expression “family of carbonates” denotes carbonates, acid carbonates (also known as hydrogen carbonates or bicarbonates), basic carbonates, formates, acetates and oxalates, which may each be optionally hydrated. Varying the degree of hydration advantageously makes it possible to refine the temperature of the gas evolution. A parting agent that is particularly suitable for the bending conditions according to the invention comprises or consists of an acid carbonate of magnesium (for example of formula MgHCO₃.n H₂O, with 0≤n≤3), a basic carbonate of magnesium (for example of formula x MgCO₃.Mg(OH)₂.n H₂O, with 1≤x≤4 and 0≤n≤5, such as 4 MgCO₃.Mg(OH)₂.5 H₂O or 3 MgCO₃.Mg(OH)₂.3 H₂O), which are optionally hydrated, or mixtures thereof.

The constituent glass sheets of the glazing according to the present invention may be manufactured according to various known processes, such as the float process in which molten glass is poured onto a bath of molten tin, and the process of rolling between two rollers (or “fusion draw” process), in which the molten glass overflows from a channel and forms a sheet by gravity, or else the “down-draw” process, in which the molten glass flows downward through a slot, before being drawn to the desired thickness and simultaneously cooled.

The first and second glass sheets may have identical or different thicknesses. When they have different thicknesses, the first glass sheet is generally the thickest sheet. The glass sheets have a thickness of at most 2.6 mm, preferably of at most 2.1 mm, or of at most 1.6 mm. In one particular embodiment, the second glass sheet is thinner than the first glass sheet. The second glass sheet then has a thickness of at most 1.5 mm, or of at most 1.1 mm or even less than or equal to 1 mm. Advantageously, the second glass sheet has a thickness of less than or equal to 0.7 mm. The thickness of the first glass sheet is preferably at least 1.4 mm, or at least 1 mm. The thickness of the second glass sheet is preferably at least 0.3 μm. The use of thin glass sheets makes it possible to lighten the laminated glazing and consequently meets the specifications currently demanded by manufacturers who are seeking to reduce the weight of vehicles.

The step of bending the first and second glass sheets is carried out simultaneously. The two glass sheets are positioned on top of one another on a bending support, if necessary, the thinnest glass sheet being the one on top, furthest from the support.

The two sheets are separated by the parting agent according to the invention in order to prevent one sheet from sticking to the other. The parting agent is typically applied to the glass sheet in the form of dry powder, suspension or solution in a liquid so as to obtain a homogeneous dispersion thereof on the surface of the glass sheet, for example by spraying methods well known to a person skilled in the art. The parting agent is preferably in powder form. It may be applied to the glass sheet in a proportion of at least 0.1 g/m², or 0.2 g/m², and generally up to 50 g/m², or 40 g/m². The powder typically has a particle size of less than 150 μm, preferably less than 100 μm, typically from 1 to 80 μm, or from 5 to 60 μm, the lower limits corresponding to D₅ (diameter for which 5% of the particles have smaller diameters) and the upper limits corresponding to D₉₅ (diameter for which 95% of the particles have smaller diameters). The size of the particles may be measured by laser diffraction.

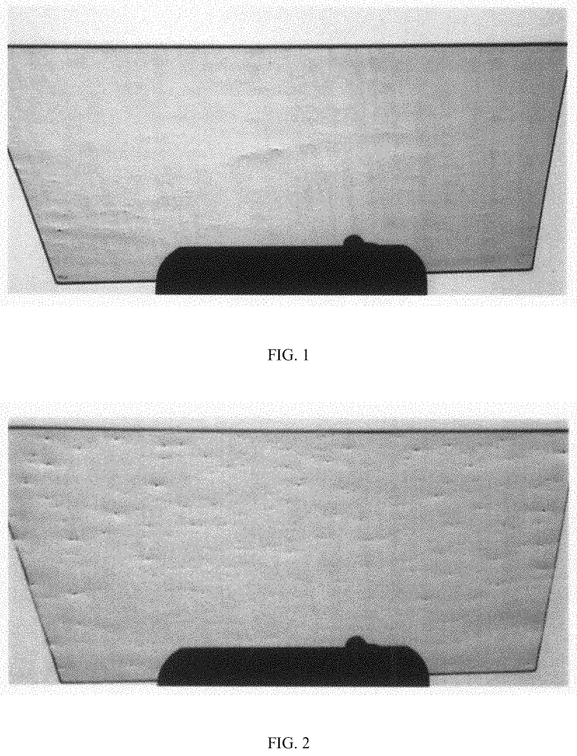

The bending may be carried out by any method known to a person skilled in the art, for example techniques of gravity (or sag) bending, press bending, suction bending or combinations thereof. In one particular embodiment, the bending may be carried out by gravity on a support of frame or skeleton type, in particular of double skeleton type (as described for example in EP 0448447, EP 0705798 and WO 2004/103922). In another particular embodiment, the bending may in particular be carried out by forming on a solid bending mold using a pressing force. The force for pressing the glass against said mold may be of mechanical or pneumatic nature. If the force is of mechanical nature it may be applied by a solid or frame-shaped countermold. In particular, it may be a frame as represented under the reference (4) of FIG. 1 of WO 95/01938 or the segmented frame referenced (9, 10, 11, 12) in FIGS. 1 and 2 of U.S. Pat. No. 5,974,836. If the force is of pneumatic nature, it may be applied by suction through the solid mold by means of orifices in the contact surface of said solid mold as represented in FIG. 2 of WO 2006/072721. A pneumatic force may also be applied by means of a skirt surrounding the solid mold on the model of the skirt referenced 16 in FIG. 2 of WO 04087590. The skirt provides a suction force that generates a flow of air surrounding the sheet by lapping the edge thereof. However, the pneumatic force exerted by a skirt is generally insufficient and is preferably supplemented by a force of mechanical or pneumatic nature across the solid mold. In another particular embodiment, the bending may also comprise forming against a solid mold preceded by a bending by another process, in particular and preferably by gravity bending. The existence of such gravity pre-bending is precisely preferred because it ultimately makes it possible to increase the complexity of the glazing (greater depths of bending in all directions), without degrading the level of optical quality of the glazing.

During the bending step, the sheets of glass, at the point located on the normal to its surface passing through its barycenter, generally reach a temperature of between 590° C. and 670° C. For gravity bending, this temperature is preferably between 610° C. and 670° C. For bending against a solid mold, it is preferably between 590° C. and 630° C.

The present invention also relates to a process for manufacturing a laminated glazing comprising a step of simultaneous bending of superposed glass sheets as described above, and a step of laminating the two glass sheets with a polymer interlayer.

When the second glass sheet is a thin glass sheet, this sheet is preferably chemically tempered in order to reinforce its mechanical strength. Chemical tempering is a process which consists in carrying out an ion or exchange within the glass sheet: the superficial substitution of an ion (generally an alkali metal ion such as sodium or lithium) by an ion of larger ionic radius (generally another alkali metal ion, such as potassium or sodium) from the surface of the glass makes it possible to create, at the surface of the glass sheet, residual compressive stresses that make it possible to obtain the desired strength. In this case, the process comprises, before the laminating step, a step of chemical tempering of the second glass sheet. The chemical tempering is generally carried out by placing said sheet in a bath filled with a molten salt of the desired alkali metal ion. This exchange customarily takes place at a temperature below the transition temperature of the glass and the degradation temperature of the bath, advantageously at a temperature below 490° C. The duration of the chemical tempering is preferably less than 24 hours. However, it may be desirable for the chemical tempering time to be shorter in order to be compatible with the productivities of the processes for manufacturing laminated glazings for motor vehicles. In this case, the duration of the tempering is for example less than or equal to 4 hours, preferentially less than or equal to 2 hours. The temperatures and durations of the tempering should be adjusted as a function of the composition of the glass, of the thickness of the glass sheet, and also of the thickness in compression and of the desired level of stresses. In particular, good performances are obtained regarding the tempering when it is carried out for a duration of 2 hours at a temperature of 460° C. The ion exchange may advantageously be followed by a step of heat treatment in order to reduce the internal tensile stress and increase the depth of compression.

The laminating step is carried out in a manner known to a person skilled in the art. It comprises the assembling of the glass sheets with the thermoplastic interlayer by placing under pressure in an autoclave and raising the temperature.

The polymer interlayer placed between the glass sheets consists of one or more layers of thermoplastic material. It may in particular be made of polyurethane, polycarbonate, polyvinyl butyral (PVB), polymethyl methacrylate (PMMA), ethylene-vinyl acetate (EVA) or ionomer resin. The polymer interlayer may be in the form of a multilayer film having particular functionalities, for instance better acoustic properties, UV-stabilizing properties, etc. Conventionally, the polymer interlayer comprises at least one layer of PVB. The thickness of the polymer interlayer is between 50 μm and 4 mm. Generally, its thickness is less than 1 mm. In motor vehicle glazings, the thickness of the polymer interlayer is conventionally 0.76 mm. When the constituent glass sheets of the glazing are very thin, it can be advantageous to use a polymer sheet with a thickness of greater than 1 mm, or greater than 2 or 3 mm, in order to give the laminated glazing rigidity, without providing an excessive increase in weight.

The present invention also relates to a curved laminated glazing capable of being obtained by the process described above. Such a glazing has an improved optical quality. This improvement is particularly substantial when the bending is a press bending. The laminated glazing thus obtained advantageously constitutes a motor vehicle glazing and in particular a windshield. The second glass sheet constitutes, once the laminated glazing is fitted in the vehicle, the internal glass sheet, i.e. the one placed toward the inside of the passenger compartment. The first glass sheet therefore constitutes the one which is placed toward the outside.

The examples below illustrate the invention without limiting the scope thereof.

In order to evaluate the effectiveness of the parting agents on the laboratory scale, a glass sheet with dimensions of 30×30 cm and a thickness of 1.6 mm is laid flat on a sheet of glass-ceramic and heated in a furnace. For a furnace temperature stabilized at 620° C., the rise in temperature is 11 minutes. The maximum temperature is then maintained for 9 minutes. The maximum temperature reached by the glass sheet is 615° C. This test reproduces conditions more drastic than the industrial process for simultaneous bending of two glass sheets by pressing since the glass-ceramic sheet does not deform at these temperatures.

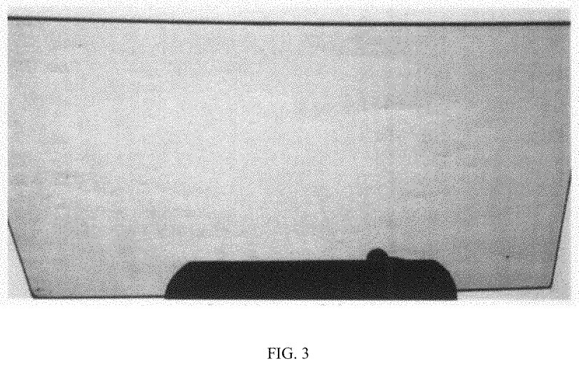

Three series of tests (comparative series 1, comparative series 2 and series 3 according to the invention) were carried out by placing a parting agent between the glass sheet and the glass-ceramic sheet. The parting agent used is respectively a calcium carbonate of formula CaCO₃ for series 1, an acid carbonate of sodium of formula NaHCO₃ for series 2, and a basic carbonate of magnesium of formula 4 MgCO₃. Mg(OH)₂.5 H₂O for series 3. The optical defects (pinholes) were then observed on the glass sheets. The glass sheets of series 1 and 2 respectively had a high or very high number of pinholes (see FIG. 1 and FIG. 2). On the contrary, the glass sheets of series 3 had only very few pinholes (FIG. 3).

Thermogravimetric and thermodifferential analyses of these three parting agents, coupled with a mass spectrometry, were carried out in order to understand the behavior of these parting agents. These analyses revealed that, under the bending conditions (rapid rise in temperature of the order of 50° C./min, and under a stream of CO₂), the basic carbonate of magnesium decomposes releasing water and carbon dioxide mainly over a temperature range of from 450° C. to 640° C. The loss of mass over this temperature range is around 36% and the volume of gas released is around 0.18 l/g. On the contrary, the calcium carbonate does not undergo any decomposition for temperatures below 640° C. As regards the acid carbonate of sodium, its decomposition mainly takes place at temperatures below 250° C., i.e. much lower than the bending temperatures. Furthermore, the decomposition residue of the acid carbonate of sodium, highly reactive Na₂O, is capable of impairing the surface of the glass sheet. This is not the case for the decomposition residue of the basic carbonate of magnesium, MgO, which is inert.

Two series of tests (comparative series 4 and series 5 according to the invention) were carried out on an industrial windshield production line. The bending is carried out by pressing on a solid mold at temperatures of 610-620° C. For each of the series of tests, a powdered parting agent was distributed homogeneously on the surface of the glass sheet. The parting agent used is respectively a calcium carbonate of formula CaCO₃ for series 4 and a basic carbonate of magnesium of formula 4 MgCO₃.Mg(OH)₂.5 H₂O for series 5. After bending, the optical defects of the glass sheets were observed by shadowgraphy. The number of optical defects observed was significantly reduced on the glass sheets of series 5 compared to those of series 4. This industrial test therefore confirms the advantage of the parting agent according to the invention for reducing the number of optical defects in the manufacture of laminated curved glazings.

1. A process for simultaneous bending of superposed glass sheets comprising:
the provision of a first glass sheet;
the application of a parting agent to one surface of the first glass sheet;
the provision of a second glass sheet superposed on the first glass sheet, the parting agent being between the first glass sheet and the second glass sheet;
the heating of the glass sheets at a temperature that allows the bending thereof; and
the simultaneous bending of the glass sheets;
characterized in that the parting agent generates gas evolution under the bending conditions.

2. The process as claimed in claim 1, characterized in that the volume of gas released by the parting agent between 450° C. and 640° C. is at least 0.05 l/g.

3. The process as claimed in either one of claims 1 and 2, characterized in that the gas evolution is an evolution of water and/or carbon dioxide.

4. The process as claimed in any one of claims 1 to 3, characterized in that the parting agent is applied in powder form.

5. The process as claimed in claim 4, characterized in that the powder has a particle size of less than 150 μm, preferably of less than 100 μm, typically of from 1 to 80 μm, or from 5 to 60 μm.

6. The process as claimed in any one of claims 1 to 5, characterized in that the parting agent is applied to the first glass sheet in a proportion of at least 0.1 g/m².

7. The process as claimed in any one of claims 1 to 5, characterized in that the parting agent is chosen from the family of carbonates, alumina hydroxides, hydrated mixed silicates or a mixture thereof.

8. The process as claimed in any one of claims 1 to 7, characterized in that the parting agent comprises an acid magnesium carbonate, a basic magnesium carbonate, each optionally being hydrated, or mixtures thereof.

9. The process as claimed in any one of claims 1 to 8, characterized in that the glass sheets have a thickness of at most 2.1 mm, preferably at most 1.6 mm.

10. The process as claimed in any one of claims 1 to 9, characterized in that the second glass sheet is thinner than the first glass sheet.

11. The process as claimed in claim 10, characterized in that the second glass sheet has a thickness of at most 1.5 mm, preferably of at most 1.1 mm, or less than 1 mm or even less than or equal to 0.7 mm.

12. The process as claimed in any one of claims 1 to 11, characterized in that the sheets of glass, at the point located on the normal to its surface passing through its barycenter, reach a temperature of between 590° C. and 670° C.

13. The process as claimed in any one of claims 1 to 12, characterized in that the bending is press bending.

14. A process for manufacturing a laminated glazing comprising a step of simultaneous bending of superposed glass sheets as claimed in any one of claims 1 to 13 and a step of laminating the two glass sheets with a polymer interlayer.

15. The process as claimed in claim 14, characterized in that it comprises, before the laminating step, a step of chemical tempering of the second glass sheet.

16. A curved laminated glazing capable of being obtained by the process as claimed in claim 14 or 15.
